(19) United States
(12) Patent Application Publication
(10) Pub. No.: US 2026/0150907 A1
(43) Pub. Date: Jun. 4, 2026

(54) AEROSOL PROVISION DEVICE

(71) Applicant: Nicoventures Trading Limited, London (GB)

(72) Inventors: Matthew HODGSON, London (GB); Dean COWAN, London (GB)

(21) Appl. No.: 19/122,697

(22) PCT Filed: Oct. 17, 2023
(86) PCT No.: PCT/EP2023/078850

§ 371 Date: Apr. 18, 2025

(30) Foreign Application Priority Data
Oct. 21, 2022 (GB) 2215583.2

(51) Int. Cl. A24F 40/10; A24F 40/50

(52) U.S. Cl. CPC A24F 40/57; A24D 1/20; A24F 40/20; A24F 40/46; H05B 6/108

(57) ABSTRACT

An aerosol provision device is configured to receive at least a portion of an article comprising aerosol generating material, the aerosol provision device comprising an article sensor and a processor, wherein the article sensor comprises a receiver for receiving a receiver signal from the article, the receiver signal indicative of article information, wherein the processor is configured to: determine whether the receiver signal has a receiver signal strength below a detection threshold; and in response to the receiver signal strength being below the detection threshold, modify an operation parameter of the article sensor to increase the receiver signal strength.

### CROSS-REFERENCE TO RELATED APPLICATIONS

This present application is a National Phase entry of PCT Application No. PCT/EP2023/078850, filed Oct. 17, 2023, which claims priority from GB 2215583.2, filed Oct. 21, 2022, each of which are fully incorporated herein by reference in their entireties.

### TECHNICAL FIELD

The present invention relates to an aerosol provision device, an aerosol provision system and an article.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating an aerosol from aerosol generating material of an article. The aerosol provision device comprises: an aerosol generator comprising a heating arrangement, the heating arrangement configured to heat the aerosol generating material during an aerosol generation session; and a controller. The controller is configured to: receive a proximity signal, the proximity signal indicative of an article being in proximity to the aerosol provision device; and, in response to receiving the proximity signal, control the heating arrangement to begin pre-heating.

The controller may be configured to receive an article received signal, the article received signal indicative of the article being received by the aerosol provision device; and in response to receiving the article received signal, control the heating arrangement to begin the aerosol generation session.

The aerosol provision device may comprise an article proximity detector, the article proximity detector configured to: determine that the article is in proximity to the aerosol provision device; and in response to determining that the article is in proximity to the aerosol provision device, transmit the proximity signal to the controller.

The article may be within proximity when it is within a detection distance of the aerosol provision device.

The detection distance may be less than 30 cm. The detection distance may be less than 25 cm. The detection distance may be less than 20 cm.

The detection distance may be greater than 10 cm. The detection distance may be greater than 15 cm. The detection distance may be substantially 20 cm.

The proximity detector may be a near field communication (NFC) communicator. The proximity detector may be an active near field communication component configured to communicate with a passive near field communication component in the article.

The aerosol provision device may comprise an article received detector, the article received detector configured to: determine that the article has been received by the aerosol provision device; and in response to determining that the article has been received by the aerosol provision device, transmit the article received signal to the controller.

The article received detector may be a pressure sensor.

The article received detector may be the proximity detector.

The aerosol provision device may comprise a first heater and a second heater, wherein the controller is configured to control the first heater to heat during pre-heating, wherein the controller is configured to control the first and second heaters to heat during the aerosol generation session.

The aerosol provision device may further comprise a device housing, wherein the heating arrangement extends from the device housing.

The heating arrangement may comprise an internal heater, the internal heater configured to be received inside the article to heat the aerosol generating material.

The heating arrangement may comprise an external heater, the external heater configured to surround article to heat the aerosol generating material. The external heater may extend from the device housing. The external heater may be the first heater. The controller may be configured to control the external heater to heat during pre-heating. The external heater may be the second heater.

The internal heater may be the second heater. The internal heater may be the first heater. The controller may be configured to control the external heater to heat during pre-heating. The controller is configured to control the heating arrangement to heat at a first temperature during pre-heating and a second temperature during the aerosol generation session, wherein the second temperature is higher than the first temperature. The first temperature may be more than 50 deg C. The first temperature may be more than 60 deg C. The first temperature may be less than 120 deg C. The first temperature may be less than 80 deg C. The first temperature may be less than 70 deg C.

The aerosol generation session may define a time period in which a user may perform several inhales on the aerosol provision device.

The controller may be configured to: receive a distance signal after receiving the proximity signal, the distance signal indicative of the article no longer being in proximity to the article; in response to receiving the distance signal, controlling the heating arrangement to stop pre-heating.

The aerosol provision device may comprise a timer element, wherein the timer element is configured to send the distance signal if a received signal is not received by the controller within a pre-heating time period of the proximity signal being received. The timer element may send the distance signal if the aerosol generation session has not started within the pre-heating time period of the proximity signal being received.

The article proximity detector may be configured to: determine that the article is no longer in proximity to the aerosol provision device; and in response to determining that the article is no longer within proximity to the aerosol provision device, transmit the distance signal to the controller.

In accordance with some embodiments described herein, there is provided a system comprising an aerosol provision device as described above and the article.

In accordance with some embodiments described herein, there is provided a method comprising determining that an article is in proximity to an aerosol provision device, the article comprising aerosol generating material, and the aerosol provision device comprising an aerosol generator comprising a heating arrangement configured to heat the aerosol generating material during an aerosol generation session; and in response to the article being in proximity to the aerosol provision device, controlling the heating arrangement to begin pre-heating.

In accordance with some embodiments described herein, there is provided an article comprising: aerosol generating material; and an article indicator configured to provide an article signal to an aerosol provision device, the article signal indicative of a proximity of the article to the aerosol provision device.

In accordance with some embodiments described herein, there is provided an aerosol provision system for generating an aerosol from aerosol generating material of an article, the aerosol provision system comprising: an aerosol provision device; an aerosol generator comprising a heating arrangement, the heating arrangement configured to heat the aerosol generating material during an aerosol generation session; and a controller configured to: receive a proximity signal, the proximity signal indicative of an article being in proximity to the aerosol provision device; and in response to receiving the proximity signal, control the heating arrangement to begin pre-heating.

The article may comprise an article indicator configured to provide an article signal to an aerosol provision device, the article signal indicative of a proximity of the article to the aerosol provision device.

The article may comprise the aerosol generating material.

The aerosol generating material may be a liquid.

The article may comprise the aerosol generator.

The aerosol provision device may comprise an energy storage configured to supply energy to the article.

The article may be a cartridge.

The method may comprise any of the functional steps described with respect to the aerosol provision device, the aerosol provision systems and/or the article. The aerosol provision device may comprise any features described with respect to the method, the aerosol provision systems and/or the article. The article may comprise any features described above with respect to the method, the aerosol provision systems and/or the aerosol provision device. The aerosol provision system may comprise any features described with respect to the aerosol provision device, the method and/or the article.

### BRIEF DESCRIPTION OF THE DRAWINGS

Embodiments will now be described, by way of example only, and with reference to the accompanying drawings in which:

FIG. 1 shows a cross-sectional side view of an aerosol provision device and an article;

FIG. 2 shows a cross-sectional side view of an aerosol provision system; and

FIG. 3 shows a method of operating an aerosol provision device.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 w t% of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The sheet may be a crimped sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and an article, typically a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

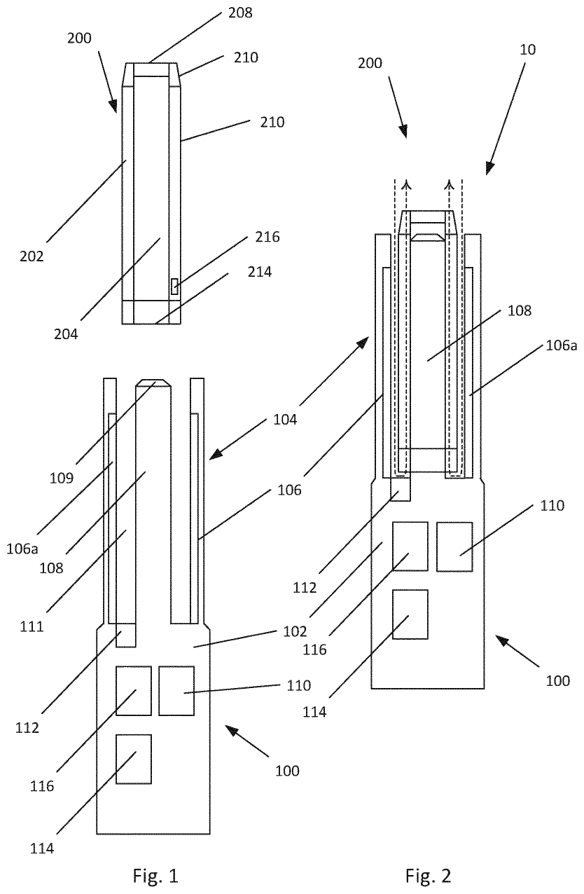

With reference to FIG. 1 and FIG. 2, an aerosol provision system 10 comprises an aerosol provision device 100 for generating aerosol from an aerosol generating material. The aerosol provision system 10 further comprises a replaceable article 200 comprising the aerosol generating material. In broad outline, the aerosol provision device 100 may be used to heat the article 200 to generate an aerosol or other inhalable medium, which is inhaled by a user of the device 100. Though FIG. 1 and FIG. 2 show the same aerosol provision device 100 and article 200, several reference numerals are omitted from FIG. 1 or FIG. 2 for clarity.

The aerosol provision device 100 comprises a housing 102. The housing 102 houses various components of the aerosol provision device 102.

The aerosol provision device 100 comprises an aerosol generator 104. The aerosol generator 104 is a heating arrangement 104. The heating arrangement 104 comprises an internal heating arrangement 108. The heating arrangement 104 comprises an external heating arrangement 106. The internal heating arrangement 108 is configured to be received inside the article 200. The internal heating arrangement 108 is configured to heat the article 200 from the inside. The external heating arrangement 106 is configured to receive the article 200 inside it. The external heating arrangement 106 is configured to heat the article 200 from the outside.

The internal heating arrangement 108 is elongate. The internal heating arrangement 108 is substantially cylindrical. The internal heating arrangement 108 comprises a short, frustoconical end portion 109, such that the internal heating arrangement tapers at a distal end. The internal heating arrangement 108 has a diameter of approximately 7 mm. The internal heating arrangement comprises a resistive heating element (not shown in the figures).

The internal heating arrangement 108 extends away from the housing 102. The internal heating arrangement 108 is not surrounded by the housing 102.

The external heating arrangement 106 is a tubular body 106. The external heating arrangement 106 has a circular cross-section. The external heating arrangement 106 comprises an induction heater. The induction heater comprises an inductive element (which is a coil, not shown) and a susceptor (which is a tube, not shown). The inductive element surrounds the susceptor. The susceptor surrounds the article in use.

Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

In other examples, the external heating arrangement 106 comprises a resistive heating element. The internal heating arrangement 108 may comprise an induction heater.

The external heating arrangement 106 extends away from the housing 102. In the present example, the external heating arrangement 106 is not surrounded by the housing 102. The external heating arrangement may have a housing distinct from the housing 102. In other examples, the external heating arrangement 106 is covered by the housing 102.

An article receptacle 111 is formed between the internal heating arrangement 108 and the external heating arrangement 106. The article receptacle 111 has an annular shape.

The aerosol provision device 100 comprises an article proximity detector 110. The article proximity detector 110 is a near field communication (NFC) communicator. The article proximity detector 110 is an active NFC communicator. The article proximity detector 110 is configured to transmit and receive radio-frequency signals.

The aerosol provision device 100 comprises an article received detector 112. The article receiver detector 112 is a pressure sensor 112. The pressure sensor 112 is positioned at the bottom of the article receptacle 111, such that it is activated by a distal end of the article 200 when the article 200 is received in the receptacle 111.

In other examples, the article received detector is a light sensor. The light sensor may be positioned at the bottom of the article receptacle, such that is activated by the article when the article is received in the receptacle.

In other examples, the article received detector is an RF signal sensor. The RF signal sensor may be positioned at the bottom of the article receptacle, such that it is activated by the article when the article is received in the receptacle.

The aerosol provision device 100 comprises a power source 114 for supplying power to the aerosol generator 104. The aerosol provision device 100 comprises a controller 116. The power source 114 is in the housing 102. The controller 116 is in the housing 102. The power source supplies electrical power to the aerosol generator, and the aerosol generator converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source is electrically coupled to the aerosol generating assembly to supply electrical power when required and under control of the controller 116 to heat the aerosol generating material. The controller may be configured to activate and deactivate the aerosol generating assembly based on a user input. The controller is housed in the housing.

The article 200 comprises aerosol generating material 202. The article 200 comprises a cavity 204. The cavity 204 is cylindrical. The aerosol generating material 202 is tubular. The aerosol generating material 202 surrounds the cavity 204. The article 200 comprises a mouth end 208. The mouth end 208 is received in the user's mouth in use. The article 200 comprises a filter element 210. The filter element 210 is at the mouth end 208. The article 200 comprises an outer surface 212. The outer surface 212 is formed from paper. The article 200 comprises a distal end 214 opposite the mouth end 208.

The article 200 comprises an article communicator 216. The article communicator 216 is an NFC communicator. The article communicator 216 is a passive communicator. The article communicator 216 is located at the distal end 214 of the article 200. The article communicator 216 is configured to receive and transmit radio frequency signals.

In use, the article proximity detector 110 transmits a first signal. The first signal is a radio frequency signal. When the aerosol provision device 100 is in an idle state, the article proximity detector 110 transmits the first signal periodically with a first period, for example wherein the first period is 30 s. When the aerosol provision device 100 is in an active state, the article proximity detector 110 transmits the first signal periodically with a second period, wherein the second period is shorter than the first period, for example, wherein the second period is 0.5 s. The aerosol provision device 100 may transition from the idle state to the active state in response to a user input (e.g. a button press, slide switch or touch sensor) or in response to a signal from an active state detector. The active state detector may be a motion sensor configured to detect motion of the aerosol provision device, a temperature sensor configured to detect an ambient temperature change, a microphone configured to detect a sound or another sensor configured to detect user behaviour. The article proximity detector 110 may send the first signal in response to the signal from the active state detector.

When the article 200 is brought within a detection distance of the aerosol provision device 100, the first signal is received by the article communicator 216. The first signal provides power to the article communicator 216. The article communicator 216 uses the power to transmit a second signal to the article proximity detector 110. The receipt of the second signal at the article proximity detector 110 indicates that the article 212 is within the detection distance, allowing the article proximity detector 110 to determine that the article 200 is in proximity to the aerosol provision device 100. The detection distance is 20 cm. The detection distance may be reduced if there are obstacles (e.g. a metal obstacle) between the article proximity detector 110 and the article communicator 216.

In response to receiving the second signal, the article proximity detector 110 transmits a proximity signal to the controller 110, in this example via a wired connection (not shown). The proximity signal is indicative of the article 200 being in proximity to the aerosol provision device 100.

The controller 116 receives the proximity signal. In response to receiving the proximity signal, the controller 116 controls the heating arrangement 104 to begin preheating. During pre-heating, the controller 116 controls one of the external heating arrangement 106 and the internal heating arrangement 108 to produce heat, and the other of the external heating arrangement 106 and the internal heating arrangement 108 not to produce heat. During pre-heating, the controller 110 controls the external heating arrangement 106 to begin producing heat. During pre-heating, the controller 116 controls the heating arrangement 104 to heat the aerosol generating material 202 to a first temperature. In the present example the first temperature is 65 deg C. Such a first temperature may permit the heating arrangement 104 to heat the aerosol generating material 202 to the second temperature (as described below) within 2 s of the start of the aerosol generation session.

In other examples, the article proximity detector 110 may be configured to monitor other electromagnetic properties of the article 200, for example, material properties, temperature, movement, magnetic field. The article proximity detector 110 may also be capacitance detector configured to detect a change in capacitance resulting from the article 200 approaching the aerosol provision device.

When the article 200 is inserted into the receptacle 111, the article 200 actuates the article received detector 112. The distal end 218 contacts the pressure sensor 112 to actuate the article received detector 112. The article received detector 112 thereby determines that the article 200 has been received by the aerosol provision device 100.

In response to determining that the article 200 has been received by the aerosol provision device 100, the article received detector 112 transmits an article received signal to the controller 116, in this example via the wired connection (not shown). The article received signal is indicative of the article 200 being received in the aerosol provision device 100.

The controller 116 receives the article received signal. In response to receiving the article received signal, the controller 116 controls the heating arrangement 104 to begin the aerosol generation session. During the aerosol generation session, the controller 166 controls both the external heating arrangement 106 and the internal heating arrangement 108 to produce heat. During the aerosol generation session, the controller 116 controls the heating arrangement 104 to heat the aerosol generating material 202 to a second temperature. The second temperature is higher than the first temperature. In the present example the temperature is 225 deg C. The aerosol generation session defines a time period in which the user makes multiple inhales on the aerosol provision device 100, with the aerosol generating material 202 temperature being controlled to be substantially constant. The controller 116 may control only a portion of the aerosol generating material 202 to the second temperature at any one time during the aerosol generation session. In response to a user inhaling on the aerosol provision device, the controller may control a different portion of the aerosol generating material 202 to the second temperature i.e. progressively heating different portions of the aerosol generating material 202.

In other examples, the heating arrangement 104 may be controlled to heat to the second temperature only during an inhale, with the heating arrangement 104 returning to a lower temperature (e.g. the first temperature) between inhales in the aerosol generation session. In such examples, the start of the aerosol generation session may be marked by an inhale detector beginning detecting inhales or by the temperature of the heating arrangement 104 being controlled to the second temperature in response to inhales being detected.

In other examples, the heating arrangement may comprise only one heater (internal or external), which may be controlled to heat to the first temperature during pre-heating and the second temperature during the aerosol generation session.

The article 200 is received in the article receptacle 111, as shown in FIG. 2. The internal heating arrangement 106 extends into the article 200. The external heating arrangement 108 extends around the article 200.

An inlet flow path 118 to the article 200 permits air to flow from outside the aerosol provision system 10 to the article 200. The inlet flow path 118 is between the external heating arrangement 106 and the article 200. The inlet flow path 118 is defined by an annular volume. In other examples, air flows from an air inlet (e.g. an aperture) at the base of the article receptacle 111.

When a user inhales on the article 200, air flows between the external heating arrangement 106 and the article 200, through the inlet flow path 118. The air enters the article 200 through a device end (opposite to the mouth end 208) of the article 200. The air is drawn through the aerosol generating material 202, past the internal heating arrangement 108, exiting the mouth end 208 to be inhaled by the user.

The controller 116, in response to receiving the proximity signal but not the article received signal within a time period of receiving the proximity signal, the controller 116 controls the heating arrangement 106 to stop pre-heating. The time period is between 10 and 30 seconds. More specifically, the time period is 20 seconds.

In other examples, after receiving the proximity signal, the article proximity detector 110 determines again whether the article is in proximity to the aerosol provision device 100. The controller 116 controls the heating arrangement 106 to stop pre-heating in response to the article 200 no longer being in proximity to the aerosol provision device 100.

In other examples, rather than having an article received detector 112, the article proximity detector 110 is also configured to determine that the article has been received by the aerosol provision device 100, for example by detecting an increased strength of a signal transmitted from the article communicator 216. In response to determining that the article 200 has been received by the aerosol provision device 100, the article received detector 112 may transmit the article received signal to the controller 106.

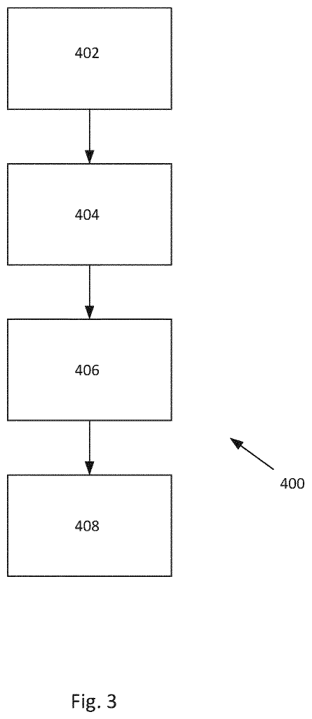

With reference to FIG. 3, there is shown a method 400 implemented by the aerosol provision device 100. The method 400 comprises an article proximity determination step 402.

The method 400 comprises a pre-heating step 404. The method 400 comprises an article received determination step 406. The method 400 comprises an aerosol generation session step 408.

In the article proximity determination step 402, a proximity signal indicative of the article 200 being in proximity to the aerosol provision device 100 is received.

In the pre-heating step 404, the heating arrangement 106 is controlled to begin pre-heating.

In the article received determination step 406, an article received signal indicative of the article 200 being received by the aerosol provision device 100 is received.

In the aerosol generation session step 408, the heating arrangement 106 is controlled to begin the aerosol generation session.

In other examples, the article may be a cartridge comprising a liquid aerosol generating material. The article may comprise the aerosol generator. The aerosol provision device may comprise an energy storage configured to supply energy to the article for aerosol generation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating an aerosol from aerosol generating material of an article, the aerosol provision device comprising:
an aerosol generator comprising a heating arrangement, the heating arrangement configured to heat the aerosol generating material during an aerosol generation session; and
a controller configured to:
receive a proximity signal, the proximity signal indicative of an article being in proximity to the aerosol provision device; and
in response to receiving the proximity signal, control the heating arrangement to begin pre-heating.

2. The aerosol provision device according to claim 1, wherein the controller is configured to:
receive an article received signal, the article received signal indicative of the article being received by the aerosol provision device; and
in response to receiving the article received signal, control the heating arrangement to begin the aerosol generation session.

3. The aerosol provision device according to claim 1, comprising:
an article proximity detector, the article proximity detector configured to:
determine that the article is in proximity to the aerosol provision device; and
in response to determining that the article is in proximity to the aerosol provision device, transmit the proximity signal to the controller.

4. The aerosol provision device according to claim 3, wherein the article is within proximity when it is within a detection distance of the aerosol provision device.

5. The aerosol provision device according to claim 4, wherein the detection distance is less than 10 cm.

6. The aerosol provision device according to claim 4, wherein the detection distance is greater than 3 cm.

7. The aerosol provision device according to claim 4, wherein the proximity detector is a NFC communicator.

8. The aerosol provision device according to claim 1, comprising an article received detector, the article received detector configured to:
determine that the article has been received by the aerosol provision device; and
in response to determining that the article has been received by the aerosol provision device, transmit the article received signal to the controller.

9. The aerosol provision device according to claim 8, wherein the article received detector is a pressure sensor actuated on receipt of the article by the aerosol provision device.

10. The aerosol provision device according to claim 1, wherein the heating arrangement comprises a first heater and a second heater, wherein the controller is configured to control the first heater to heat during pre-heating, wherein the controller is configured to control the first and second heaters to heat during the aerosol generation session.

11. The aerosol provision device according to claim 10, wherein the first heater is an external heater arranged to heat the article from the outside.

12. The aerosol provision device according to claim 1, wherein the controller is configured to control the heating arrangement to heat at a first temperature during pre-heating and a second temperature during the aerosol generation session, wherein the second temperature is higher than the first temperature.

13. An aerosol provision system comprising an aerosol provision device according to claim 1 and the article.

14. A method comprising:
determining that an article is in proximity to an aerosol provision device, the article comprising aerosol generating material, and the aerosol provision device comprising an aerosol generator comprising a heating arrangement configured to heat the aerosol generating material during an aerosol generation session; and
in response to the article being in proximity to the aerosol provision device, controlling the heating arrangement to begin pre-heating.

15. An article comprising:
aerosol generating material; and
an article indicator configured to provide an article signal to an aerosol provision device, the article signal indicative of a proximity of the article to the aerosol provision device.
